(19) United States
(12) Patent Application Publication
(10) Pub. No.: US 2025/0042250 A1
(43) Pub. Date: Feb. 6, 2025

(54) POWER TRAIN AND TRANSMISSION CASING

(71) Applicant: KAWASAKI MOTORS, LTD., Hyogo (JP)

(72) Inventors: Yasuyuki IOKU, Akashi-shi (JP); Kazuho MATSUMOTO, Akashi-shi (JP); Yuji HIDA, Akashi-shi (JP)

(21) Appl. No.: 18/229,849

(22) Filed: Aug. 3, 2023

(51) Int. Cl. B60K 17/34; B60K 17/08; F16H 37/08; F16H 57/02; F16H 57/021; F16H 57/029; F16H 57/031; F16H 57/037; F16H 57/04; F16H 63/30

(52) U.S. Cl. CPC B60K 17/34; B60K 17/08; F16H 37/0813; F16H 57/021; F16H 57/029; F16H 57/031; F16H 57/037; F16H 57/0415; F16H 63/3026; F16H 2057/02026; F16H 2057/02052

(57) ABSTRACT

A power train includes: a prime mover having a drive output shaft and a prime mover casing; a transmission casing disposed side by side with the prime mover casing in a lateral direction intersecting an axial direction of the drive output shaft and defining a transmission chamber; and a transmission including a transmission input shaft disposed in parallel with the drive output shaft, and a plurality of gear trains for shift stages of an always-meshing type disposed in the transmission chamber and shift and output power input to the transmission input shaft. The transmission casing includes: a casing body defining the transmission chamber; and an extension portion extending in the lateral direction from the casing body and fixed to the prime mover casing to define a housing chamber housing a portion of the drive output shaft protruding from the prime mover casing in cooperation with the prime mover casing.

### BACKGROUND

### Technical Field

The present disclosure relates to a power train and a transmission casing.

### Background Art

U.S. Pat. No. 7,946,953 B2 discloses a power train including an engine and a transmission to which power is input from the engine. The transmission is housed in a transmission casing disposed in front of and away from the engine.

### SUMMARY

In the above-described conventional power train, there is room for improvement in terms of reduction in the number of parts.

An object of the present disclosure is to reduce the number of parts of a power train.

According to one aspect of the present disclosure, there is provided a power train including: a prime mover having a drive output shaft, the prime mover having a prime mover casing constituting an outline of the prime mover; a transmission casing that is disposed side by side with the prime mover casing in a lateral direction intersecting an axial direction of the drive output shaft and defines a transmission chamber; and a transmission including a transmission input shaft disposed in the transmission chamber and disposed in parallel with the drive output shaft, and a plurality of gear trains for shift stages of an always-meshing type that shift and output power input to the transmission input shaft, in which the transmission casing includes: a casing body that defines the transmission chamber; and an extension portion extending in the lateral direction from the casing body and fixed to the prime mover casing to define a housing chamber that houses a portion of the drive output shaft protruding from the prime mover casing in cooperation with the prime mover casing.

According to the above configuration, since the extension portion of the transmission casing defines the housing portion that houses the portion of the drive output shaft protruding from the prime mover casing, the number of parts can be reduced as compared with a case where another member for housing the portion of the drive output shaft protruding from the prime mover casing is provided separately from the transmission casing.

### BRIEF DESCRIPTION OF DRAWINGS

The foregoing and the other features of the present disclosure will become apparent from the following description and drawings of an illustrative embodiment of the disclosure in which:

FIG. 1 is a schematic plan view of a utility vehicle equipped with a power train according to an embodiment of the present invention;

FIG. 2 is a schematic configuration diagram of a transmission mechanism;

FIG. 3 is a plan view of a transmission;

FIG. 4 is a cross-sectional view taken along the line IV-IV of FIG. 3;

FIG. 5 is a right side view of the transmission in a state where a transmission gear cover is removed; and

FIG. 6 is a left side view of the transmission in a state where a clutch cover is removed.

### DETAILED DESCRIPTION

Hereinafter, a power train and a transmission casing according to an embodiment of the present disclosure will be described with reference to the accompanying drawings. It should be noted that the following description is merely exemplary in nature and is not intended to limit the present invention, an object for application, or a usage.

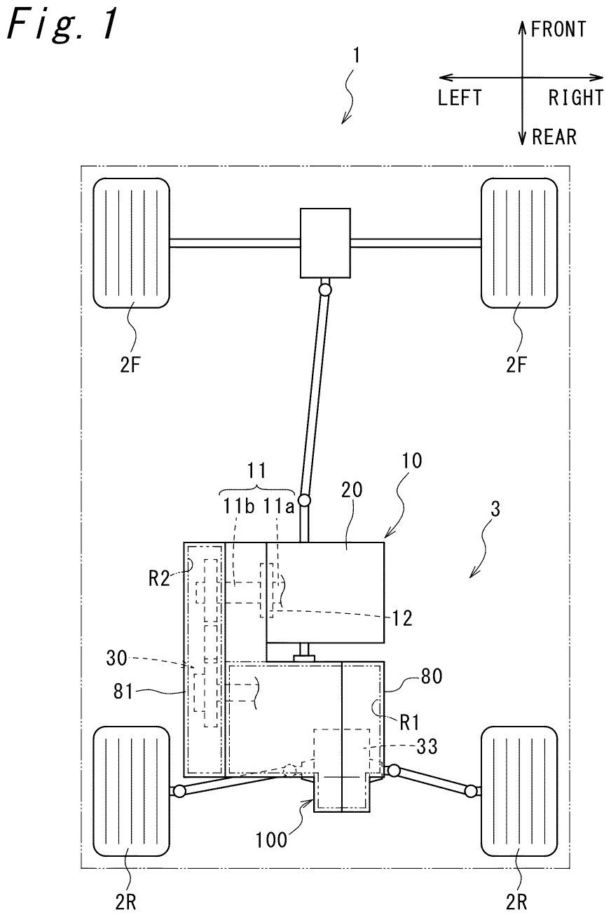

FIG. 1 is a schematic plan view of a utility vehicle 1 according to the embodiment of the present disclosure. In the following description, the front-rear direction, the left-right direction, and the upper-lower direction as viewed from a driver of the utility vehicle 1 may be simply referred to as the front-rear direction, the left-right direction, and the upper-lower direction.

The utility vehicle 1 includes wheels 2 including left and right front wheels 2F and left and right rear wheels 2R, and a power train 3 for rotationally driving the wheels 2. The left and right rear wheels 2R of the present embodiment are a pair of first drive wheels driven by the power train 3. The left and right front wheels 2F of the present embodiment are a pair of second drive wheels that can be driven by the power train 3. The utility vehicle 1 according to the present embodiment is an example of a vehicle according to the present disclosure.

The power train 3 includes a prime mover 10.

The prime mover 10 generates power for rotationally driving the wheels 2. The prime mover 10 includes a drive output shaft 11 for outputting power and a flywheel damper 12 mechanically connected to the drive output shaft 11. The prime mover 10 of the present embodiment is an engine disposed such that the drive output shaft 11 is directed the left-right direction. The prime mover 10 may include an electric motor instead of or in addition to the engine.

The drive output shaft 11 includes a crankshaft 11a and a connection shaft 11b mechanically connected to the crankshaft 11a via a flywheel damper 12. The crankshaft 11a and the connection shaft 11b are coaxially disposed.

The flywheel damper 12 is mechanically connected to a shaft end of the crankshaft 11a. The flywheel damper 12 absorbs rotational fluctuation of the prime mover 10 to reduce vibration of the drive output shaft 11. The flywheel damper 12 of the present embodiment is an example of a rotating body according to the present disclosure.

The prime mover 10 includes a crank casing 20 constituting an outline of the prime mover 10. The crank casing 20 rotatably supports the drive output shaft 11. More specifically, the crank casing 20 rotatably supports the crankshaft 11a. The crank casing 20 has an open at a left end portion. The crank casing 20 of the present embodiment is an example of a prime mover casing according to the present disclosure.

The power train 3 includes a power transmission mechanism 30 for transmitting the rotation output from the prime mover 10 to the wheels 2.

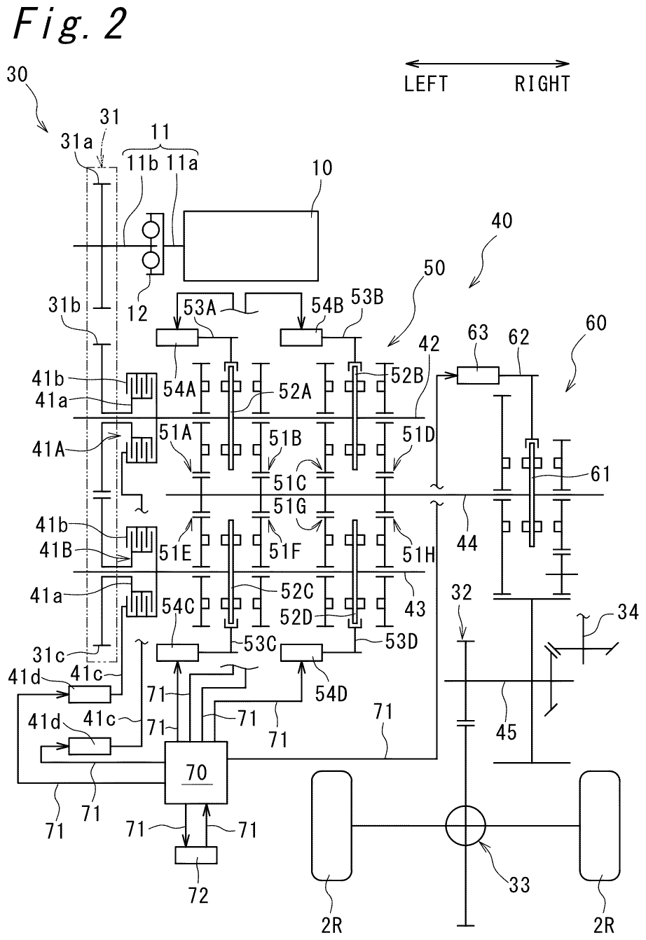

FIG. 2 is a schematic configuration diagram of the power transmission mechanism 30. Referring to FIG. 2, the power transmission mechanism 30 includes a primary deceleration mechanism 31 that decelerates and outputs the rotation output from the prime mover 10, and a transmission 40 that shifts the speed of the rotation output from the primary deceleration mechanism 31.

The primary deceleration mechanism 31 includes a driving gear 31a that rotates integrally with the drive output shaft 11, and a first driven gear 31b and a second driven gear 31c meshed with the driving gear 31a directly or via an idle gear. The driving gear 31a transmits the rotation output from the prime mover 10 to the transmission 40. The driving gear 31a is mechanically connected to the flywheel damper 12 by the connection shaft 11b. The driving gear 31a of the present embodiment is an example of a power transmission body according to the present disclosure.

The transmission 40 shifts and outputs the rotation output from the primary deceleration mechanism 31. The transmission 40 is a so-called dual clutch transmission (DCT), and includes two clutches 41A and 41B. The type of the clutches 41A and 41B is not particularly limited, and is, for example, a wet multiple disc clutch driven by hydraulic pressure.

The transmission 40 includes a first input shaft 42, a second input shaft 43, a counter shaft 44, and an output shaft 45. The first input shaft 42, the second input shaft 43, the counter shaft 44, and the output shaft 45 extend in the left-right direction in parallel with each other. The first and second input shafts 42 and 43 extend in parallel with the crankshaft 11a. The first input shaft 42 and the second input shaft 43 of the present embodiment are examples of a transmission input shaft according to the present disclosure.

The clutch 41A connects or disconnects the drive output shaft 11 to or from the first input shaft 42. The clutch 41A includes an input element 41a that rotates integrally with the first driven gear 31b and an output element 41b that rotates integrally with the first input shaft 42. The clutch 41A includes a piston 41c that axially displaces the output element 41b, and an actuator 41d that drives the piston 41c. When the actuator 41d axially displaces the output element 41b via the piston 41c, the state of the clutch 41A is switched between an engaged state in which the input element 41a and the output element 41b are engaged with each other and a disengaged state in which the input element 41a and the output element 41b are separated from each other. The rotation transmitted from the drive output shaft 11 to the input element 41a of the clutch 41A via the primary deceleration mechanism 31 is transmitted to the first input shaft 42 via the output element 41b of the clutch 41A when the clutch 41A is in the engaged state.

The clutch 41B connects or disconnects the drive output shaft 11 to or from the second input shaft 43. The clutch 41B includes an input element 41a that rotates integrally with the second driven gear 31c and an output element 41b that rotates integrally with the second input shaft 43. The clutch 41B includes a piston 41c that axially displaces the output element 41b, and an actuator 41d that drives the piston 41c. When the actuator 41d axially displaces the output element 41b via the piston 41c, the state of the clutch 41B is switched between an engaged state in which the input element 41a and the output element 41b are engaged with each other and a disengaged state in which the input element 41a and the output element 41b are separated from each other. The rotation transmitted from the drive output shaft 11 to the input element 41a of the clutch 41B via the primary deceleration mechanism 31 is transmitted to the second input shaft 43 via the output element 41b of the clutch 41B when the clutch 41B is in the engaged state.

The transmission 40 includes a transmission mechanism 50 that transmits rotation of the first or second input shaft 42 or 43 to the counter shaft 44, and a forward-reverse switching mechanism 60 that switches between a forward state and a reverse state of the utility vehicle 1.

The transmission mechanism 50 includes a plurality of gear trains for shift stages (hereinafter, which may be simply referred to as a gear train) 51A to 51H provided between the first or second input shafts 42 and 43 and the counter shaft 44. Gear ratios of the plurality of gear trains 51A to 51H are different from each other. Each gear train 51 is a gear train of an always-meshing type in which a driving gear provided on the first or second input shaft 42 or 43 so as to be relatively rotatable and a driven gear provided on the counter shaft 44 so as to be integrally rotatable are always meshed with each other.

The transmission mechanism 50 includes a plurality of dog clutches 52A to 52D provided in on one or more (in the present embodiment, two each, a total of four) on each of the first and second input shafts 42 and 43. The plurality of dog clutches 52A to 52D are used to select one gear train 51 from the plurality of gear trains 51A to 51H to be used for transmission of the rotation output from the first or second input shaft 42 or 43 to the counter shaft 44. Each of the dog clutches 52 is integrally rotatable and axially displaceable with respect to the first or second input shafts 42 and 43 provided with the dog clutch 52 in question.

The transmission mechanism 50 includes a plurality of shift forks 53A to 53D corresponding to the plurality of dog clutches 52A to 52D on a one-to-one basis. Each shift fork 53 axially displaces the corresponding dog clutch 52.

The transmission mechanism 50 includes a plurality of actuators 54A to 54D corresponding to the plurality of shift forks 53A to 53D on a one-to-one basis. Each actuator 54 drives the corresponding shift fork 53.

One dog clutch 52 of the plurality of dog clutches 52A to 52D moves in the axial direction and engages with the driving gear of one gear train 51 of the plurality of gear trains 51A to 51H, thereby making the gear train 51 in question in the power transmittable state. The rotation output from the first or second input shaft 43 is transmitted to the counter shaft 44 via the gear train 51 in the power transmittable state.

The forward-reverse switching mechanism 60 is provided between the counter shaft 44 and the output shaft 45. The forward-reverse switching mechanism 60 transmits the rotation of the counter shaft 44 to the output shaft 45, and rotates the output shaft 45 in the forward direction or the reverse direction opposite to the forward direction.

The forward-reverse switching mechanism 60 includes one dog clutch 61 provided on the counter shaft 44 so as to switch between the forward state and the reverse state of the utility vehicle 1. The dog clutch 61 is integrally rotatable and axially displaceable with respect to the counter shaft 44. The forward-reverse switching mechanism 60 includes a shift fork 62 that axially displaces the dog clutch 61, and an actuator 63 that drives the shift fork 62.

The power transmission mechanism 30 includes a final deceleration mechanism 32 that decelerates and outputs the rotation output from the output shaft 45 of the transmission 40, and a differential mechanism 33 that transmits the rotation output from the final deceleration mechanism 32 to the rear wheels 2R. The differential mechanism 33 distributes and outputs the driving force to the left and right rear wheels 2R. In addition, the power transmission mechanism 30 includes a front wheel-side output shaft 34 that is mechanically connected to the output shaft 45 and transmits power from the output shaft 45 to the front wheels 2F. The front wheel-side output shaft 34 is provided with a switching mechanism (not shown) that switches between a two-wheel drive state in which only the rear wheels 2R are driven and a four-wheel drive state in which the front wheels 2F and the rear wheels 2R are driven.

The switching operation of the power transmission state (at least a switching operation of the state of each clutch 41 and a switching operation of the state of each gear train 51) in the power transmission mechanism 30 is performed using a pressure medium. The transmission 40 includes a pressure circuit 70 for applying pressure to the actuators 41d of both the clutches 41A and 41B, the actuators 54A to 54D, and the actuator 63 via a pressure medium. In the present embodiment, by way of example only, the pressure medium is oil, and the pressure circuit 70 is a hydraulic circuit. The oil is also used for lubricating the clutches 41A and 41B, the first and second input shafts 42 and 43, the counter shaft 44, and the gear trains 51A to 51H.

The pressure circuit 70 includes a flow path 71 through which hydraulic oil as a pressure medium flows, and an oil cooler 72 for cooling the oil. The pressure circuit 70 includes a plurality of solenoid valves (not shown) for switching the oil passage.

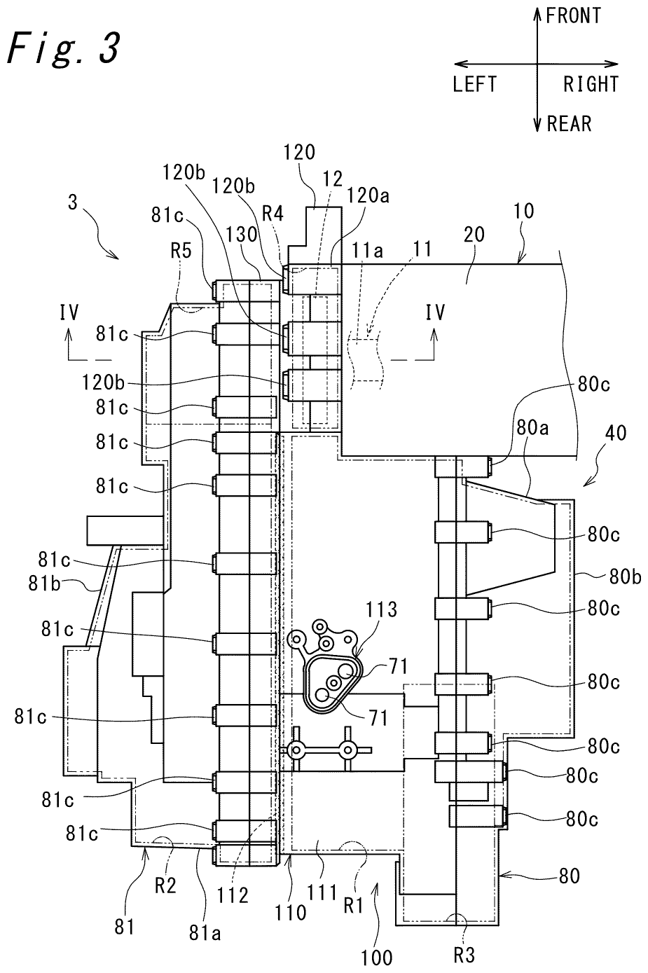

FIG. 3 is a plan view of the transmission 40. Referring to FIG. 3, the power train 3 includes a transmission casing 100, a transmission gear cover 80 attached to the right side of the transmission casing 100, and a clutch cover 81 attached to the left side of the transmission casing 100. The transmission casing 100 and the transmission gear cover 80 cooperatively define a transmission chamber R1. The transmission casing 100 and the clutch cover 81 cooperate to define a clutch chamber R2.

The transmission casing 100 is disposed side by side with the crank casing 20 in the lateral direction (the front-rear direction in the present embodiment) intersecting the axial direction of the drive output shaft 11. The transmission casing 100 includes a casing body 110 that defines the transmission chamber R1 together with the transmission gear cover 80, and an extension portion 120 extending forward from a front end portion of the casing body 110. The casing body 110 and the extension portion 120 have a non-detachable integral structure. For example, the transmission casing 100 is an integrally molded product in which the casing body 110 and the extension portion 120 have an integral structure.

The casing body 110 includes a cylindrical side wall 111 whose axis extends in the left-right direction, and a partition wall 112 that closes the left side of the side wall 111. The partition wall 112 separates the transmission chamber R1 and the clutch chamber R2 in the left-right direction. The side wall 111 closes the front side, the rear side, the upper side, and the lower side of the transmission chamber R1, and the partition wall 112 closes the left side of the transmission chamber R1.

An attachment portion 113 configured to attach the oil cooler 72 (shown in FIG. 2) is disposed in the casing body 110. The attachment portion 113 is formed with the flow path 71 through which oil supplied to the oil cooler 72 or oil discharged from the oil cooler 72 flows. In other words, the attachment portion 113 constitutes a part of the pressure circuit 70 (shown in FIG. 2).

The casing body 110 defines a differential gear chamber R3 that houses the differential mechanism 33 in cooperation with the transmission gear cover 80. The differential gear chamber R3 constitutes a part of the transmission chamber R1.

The transmission casing 100 includes the casing body 110 and a frame portion 130 rising leftward from a left side surface of the extension portion 120. The frame portion 130 has a fastening surface with the clutch cover 81. The frame portion 130 is disposed so as to surround the partition wall 112.

The transmission gear cover 80 covers the transmission casing 100 from the right. The transmission gear cover 80 closes a right opening of the transmission casing 100 defined by the casing body 110 from the right side. The transmission gear cover 80 includes a cylindrical side wall 80a whose axis extends in the left-right direction, and a right wall 80b that closes the right side of the side wall 80a. The transmission gear cover 80 is fastened to the transmission casing 100 with a bolt 80c. The side wall 80a is provided with a fastening surface with the transmission casing 100. The transmission gear cover 80 defines the transmission chamber R1 in cooperation with the transmission casing 100.

The clutch cover 81 covers the transmission casing 100 from the left. The clutch cover 81 closes the left opening of the transmission casing 100 defined by the frame portion 130 from the left side. The clutch cover 81 includes a cylindrical side wall 81a whose axis extends in the left-right direction, and a left wall 81b that closes the left side of the side wall 81a. The clutch cover 81 is fastened to the transmission casing 100 by a bolt 81c. The side wall 81a is provided with a fastening surface with the frame portion 130. The clutch cover 81 defines the clutch chamber R2 for housing the clutches 41A and 41B (shown in FIG. 2) in cooperation with the transmission casing 100.

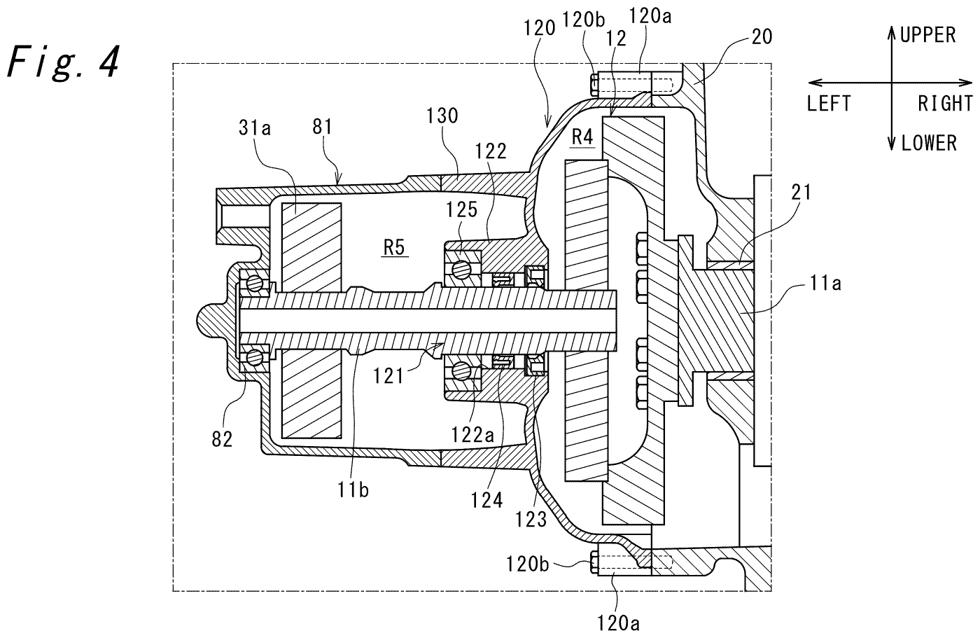

FIG. 4 is a cross-sectional view taken along the line IV-IV of FIG. 3. Referring to FIG. 4, the extension portion 120 is fixed to the crank casing 20. Specifically, a left end surface of the crank casing 20 is connected to a right end surface of the extension portion 120. More specifically, the extension portion 120 has a fixing portion 120a having a fastening surface with the crank casing 20. The fixing portion 120a is provided with a plurality of insertion holes through which a plurality of bolts 120b (only two bolts are shown in FIG. 4) for fastening the extension portion 120 to the crank casing 20 are inserted. The extension portion 120 is fastened to the crank casing 20 by the plurality of bolts 120b. Thus, the extension portion 120 closes the left opening of the crank casing 20 from the left side.

As shown in FIG. 4, a bearing 21 for rotatably supporting the crankshaft 11a is disposed in the crank casing 20. The bearing 21 of the present embodiment is a sliding bearing. The flywheel damper 12 is mechanically connected to the crankshaft 11a on the axially outer side relative to the bearing 21, that is, on the left side relative to the bearing 21.

The extension portion 120 defines a housing chamber R4 that houses a portion of the drive output shaft 11 protruding from the crank casing 20 in cooperation with the crank casing 20. Specifically, the housing chamber R4 houses the shaft end of the crankshaft 11a. The housing chamber R4 also has a function as a rotating body chamber that houses the flywheel damper 12. In other words, the flywheel damper 12 is housed in the housing chamber R4 defined by the extension portion 120 and the crank casing 20. The housing chamber R4 of the present embodiment is an example of a housing chamber according to the present disclosure, and is also an example of a rotating body chamber according to the present disclosure.

The transmission casing 100 defines, in cooperation with the clutch cover 81, an adjacent chamber R5 disposed side by side in the axial direction with respect to the housing chamber R4. The adjacent chamber R5 houses a driving gear 31a for transmitting power output from the prime mover 10 to the first or second input shaft 42 or 43. The adjacent chamber R5 constitutes a part of the clutch chamber R2 (shown in FIG. 3).

The extension portion 120 is open to the right side and has a cup shape recessed to the left side. The extension portion 120 has a shaft portion 122 provided with a hole 121 through which the connection shaft 11b is inserted. On an inner peripheral surface 122a of the shaft portion 122 that defines the hole 121, a first seal member 123 that seals the prime mover 10 side in the axial direction and a second seal member 124 that seals the clutch chamber R2 side in the axial direction are disposed. The first seal member 123 is disposed between the connection shaft 11b and the inner peripheral surface 122a of the shaft portion 122, and seals the housing chamber R4 side. This prevents the oil in the housing chamber R4 from flowing into the clutch chamber R2 through between the connection shaft 11b and the inner peripheral surface 122a of the shaft portion 122. The second seal member 124 is disposed between the connection shaft 11b and the inner peripheral surface 122a of the shaft portion 122, and seals the adjacent chamber R5 side. This prevents the oil in the clutch chamber R2 from flowing into the housing chamber R4 through between the connection shaft 11b and the inner peripheral surface 122a of the shaft portion 122. The first seal member 123 and the second seal member 124 suppress mixing of the oil in the clutch chamber R2 and the oil in the housing chamber R4. A bearing 125 that rotatably supports the connection shaft 11b is disposed on the inner peripheral surface 122a of the shaft portion 122. The first and second seal members 123 and 124 and the bearing 125 are disposed in the order of the first seal member 123, the second seal member 124, and the bearing 125 from the right side to the left side.

The clutch cover 81 is provided with a bearing 82 that rotatably supports the left end of the drive output shaft 11. Specifically, the bearing 82 rotatably supports the connection shaft 11b.

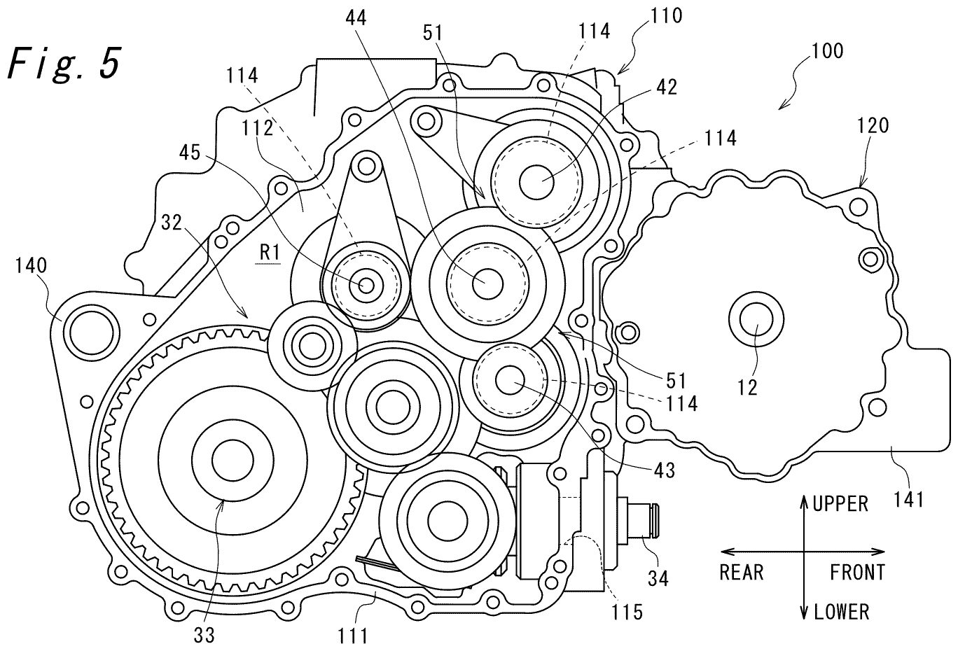

FIG. 5 is a right side view of the transmission in a state where the transmission gear cover is removed. Referring to FIG. 5, the transmission chamber R1 houses, for example, the first input shaft 42, the second input shaft 43, the counter shaft 44, and the output shaft 45. The transmission chamber R1 houses the final deceleration mechanism 32, the differential mechanism 33, and the front wheel-side output shaft 34. The transmission chamber R1 houses the transmission mechanism 50 (shown in FIG. 2) and the forward-reverse switching mechanism 60 (shown in FIG. 2). Specifically, the transmission mechanism 50 houses the plurality of gear trains 51A to 51H.

The first input shaft 42, the second input shaft 43, the counter shaft 44, and the output shaft 45 extend in parallel in the left-right direction. Each of the first input shaft 42, the second input shaft 43, the counter shaft 44, and the output shaft 45 is rotatably supported by a bearing 114 held by the partition wall 112.

The casing body 110 has a hole 115 through which the front wheel-side output shaft 34 is inserted. The hole 115 is disposed on the front side surface of the side wall 111. An inner peripheral surface of the transmission casing 100 that defines the hole 115 is disposed on the casing body 110 as a whole.

The transmission casing 100 includes a first fixing portion 140 and a second fixing portion 141 for fixing the transmission casing 100 to a vehicle body (not shown) of the utility vehicle 1 (shown in FIG. 1). The first fixing portion 140 is disposed on a rear side surface of the casing body 110 opposite to the front side surface on which the extension portion 120 is disposed. Specifically, the first fixing portion 140 is disposed on a rear portion of the side wall 111 of the casing body 110. The second fixing portion 141 is disposed on the extension portion 120.

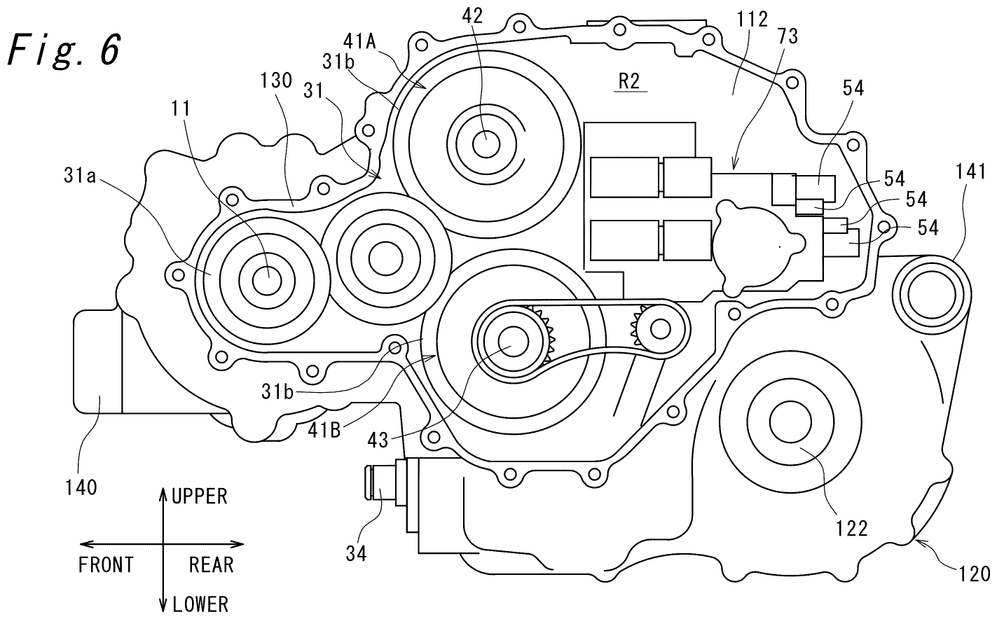

FIG. 6 is a left side view of the transmission 40 in a state where the clutch cover 81 is removed.

Left end portions of the first input shaft 42 and the second input shaft 43 protrude into the clutch chamber R2 together with an end portion of the drive output shaft 11 of the prime mover 10. The first clutch 41A, the second clutch 41B, and the primary deceleration mechanism 31 are housed in the clutch chamber R2. On the other hand, the actuator 54 is partially embedded in the partition wall 112, and is partially disposed in the transmission chamber R1 or closer to the transmission chamber R1 than the partition wall 112. At least a part of the actuator 54 is disposed in the transmission chamber R1. At least a part of the actuator 54 is disposed in the clutch chamber R2.

The transmission 40 further includes a block 73 that constitutes at least a part of the pressure circuit 70 and is attached to the partition wall 112. The block 73 is attached to an outer surface (that is, a left side surface) of the partition wall 112 and is housed in the clutch chamber R2. The block 73 may be attached to an inner surface (that is, a right side surface) of the partition wall 112 and housed in the transmission chamber R1. The block 73 constitutes a part of the flow path 71 of the pressure circuit 70.

The power train 3 according to the above embodiment provides the following aspects.

(1) The power train 3 includes: the prime mover 10 having the drive output shaft 11, the prime mover 10 having the prime mover casing (for example, the crank casing 20) constituting the outline of the prime mover 10; the transmission casing 100 that is disposed side by side with the prime mover casing in the lateral direction (for example, in the front-back direction) intersecting the axial direction of the drive output shaft 11 and defines the transmission chamber R1; and the transmission 40 including the transmission input shaft (for example, the first or second input shaft 42 or 43) disposed in parallel with the drive output shaft 11, and the plurality of gear trains 51A to 51H for shift stages of an always-meshing type that are disposed in the transmission chamber R1 and shift and output power input to the transmission input shaft. The transmission casing 100 includes: the casing body 110 that defines the transmission chamber R1; and the extension portion 120 extending in the lateral direction from the casing body 110 and fixed to the prime mover casing to define the housing chamber R4 that houses a portion of the drive output shaft 11 protruding from the prime mover casing in cooperation with the prime mover casing.

According to the above configuration, since the extension portion 120 of the transmission casing 100 seals the prime mover casing (for example, the crank casing 20), the number of parts can be reduced as compared with a case where another member for sealing the prime mover casing is provided separately from the transmission casing 100.

(2) The prime mover 10 includes the rotating body (for example, the flywheel damper 12) that is mechanically connected to the drive output shaft 11 on the axially outer side relative to the bearing 21 that supports the drive output shaft 11, and the extension portion 120 defines the rotating body chamber (for example, the housing chamber R4) that houses the rotating body in cooperation with the prime mover casing (for example, the crank casing 20).

According to the above configuration, since the extension portion 120 defines the rotating body chamber (for example, the housing chamber R4) that houses the rotating body (for example, the flywheel damper 12), the number of parts can be reduced as compared with a case where another member for defining the rotating body chamber is provided separately from the transmission casing 100.

(3) The rotating body is a damper or a flywheel.

(4) The transmission casing 100 defines the adjacent chamber R5 disposed side by side in the axial direction with respect to the rotating body chamber (for example, the housing chamber R4), and the adjacent chamber R5 houses the power transmission body (for example, the driving gear 31a) for transmitting power to the transmission input shaft (for example, the first or second input shaft 42 or 43).

(5) The drive output shaft 11 includes the connection shaft 11b that connects the power transmission body (for example, the driving gear 31a) and the rotating body (for example, the flywheel damper 12), and the extension portion 120 is fitted with the bearing 125 that rotatably supports the connection shaft 11b.

(6) The power train 3 includes: the clutch cover 81 that is attached to the transmission casing 100 and defines the clutch chamber R2; and the clutches 41A and 41B that connect or disconnect the drive output shaft 11 to or from the transmission input shaft (for example, the first or second input shaft 42 or 43) and are housed in the clutch chamber R2. The casing body 110 includes the partition wall 112 that defines the clutch chamber R2 together with the clutch cover 81.

(7) The power train 3 further includes the bearing 114 that rotatably supports the transmission input shaft (for example, the first or second input shaft 42 or 43), and the bearing 114 is supported on the partition wall 112.

(8) The power train 3 includes: the actuator 41d, 54, 63 that is disposed in one of the transmission chamber R1 and the clutch chamber R2 and is driven when a pressure medium is supplied; and the block 73 constituting at least a part of the pressure circuit 70 for applying pressure to the actuator 41d, 54, 63 via the pressure medium. The block 73 is supported on the partition wall 112.

(9) The extension portion 120 has the hole 121 through which the drive output shaft 11 is inserted. The first seal member 123 that seals the prime mover 10 side in the axial direction and the second seal member 124 that seals the clutch chamber R2 side in the axial direction are disposed on the inner peripheral surface 122a that defines the hole 121 of the extension portion 120.

(10) The casing body 110 is configured to be attached with the oil cooler 72 for cooling the oil in the transmission chamber R1.

(11) The power train 3 is mounted on the vehicle having the pair of first drive wheels (for example, the rear wheels 2R) driven by the power train 3 and the pair of second drive wheels (for example, the front wheels 2F) drivable by the power train 3 together with the pair of first drive wheels. The power train 3 further includes the transmission gear casing 80 that is fastened to the transmission casing 100 and defines the transmission chamber R1 together with the casing body 110. The transmission 40 includes the transmission output shaft (for example, the output shaft 45) extending in the transmission chamber R1. The casing body 110 has the hole 115 through which the second drive wheel side output shaft (for example, the front wheel-side output shaft 34) for transmitting power from the transmission output shaft to the pair of second drive wheels is inserted.

If a hole through which the second drive wheel side output shaft (for example, the front wheel-side output shaft 34) is inserted is provided across the transmission casing 100 and the transmission gear cover 80, machining for forming the hole needs to be performed on both the transmission casing 100 and the transmission gear cover 80. According to the above embodiment, since the hole 115 through which the second drive wheel side output shaft is inserted is provided in the casing body 110, it is not necessary to perform machining on the transmission gear cover 80. As a result, the manufacturing cost of the power train 3 can be reduced as compared with a case where the hole through which the second drive wheel side output shaft is inserted is provided across the transmission casing 100 and the transmission gear cover 80.

(12) The power train 3 is mounted on the vehicle having the pair of first drive wheels (for example, the rear wheels 2R) driven by the power train 3 and the pair of second drive wheels (for example, the front wheels 2F) drivable by the power train 3 together with the pair of first drive wheels. The power train 3 further includes the differential mechanism 33 that distributes the power transmitted from the transmission output shaft 45 extending in the transmission chamber R1 to the pair of first drive wheels. The differential mechanism 33 is housed in the casing body 110.

(13) The power train 3 is mounted on the vehicle having the vehicle body that supports the power train 3. The transmission casing 100 includes: the first fixing portion 140 that is disposed on the side surface of the casing body 110 opposite to a side surface on which the extension portion 120 is disposed and fixes the transmission casing 100 to the vehicle body; and the second fixing portion 141 that is disposed on the extension portion 120 and fixes the transmission casing 100 to the vehicle body.

(14) The transmission casing 100 is configured to be fixed to the prime mover casing (for example, the crank casing 20) that houses the prime mover 10 having the drive output shaft 11, and is configured to be disposed side by side with the prime mover casing in the lateral direction intersecting the axial direction of the drive output shaft 11. The transmission casing 100 includes: the casing body 110 that defines the transmission chamber R1 for housing the transmission 40; and the extension portion 120 extending from the casing body 110 in the lateral direction and configured to seal the prime mover casing when fixed to the prime mover casing.

Various modifications and changes can be made without departing from the scope of the present disclosure.

In the above embodiment, the drive source output shaft 11 includes the crankshaft 11a and the connection shaft 11b mechanically connected to the crankshaft 11a via the flywheel damper 12, but the invention is not limited thereto. The power train according to the present disclosure may not include the flywheel damper 12 and the connection shaft 11b. In this case, the driving gear 31a may be mechanically connected to the crankshaft 11a and rotate integrally with the crankshaft 11a.

The type of the transmission 40 is not limited to the DCT.

In the above embodiment, the flywheel damper 12 has been described as an example of the rotating body of the present disclosure, but the rotating body of the present disclosure is not limited thereto, and may be either a flywheel or a damper.

In the above embodiment, the drive output shaft 11 extends in the left-right direction, but the present invention is not limited thereto, and the drive output shaft 11 may extend in the front-rear direction. In the above embodiment, the drive output shaft 11 extends toward the left side, but the drive output shaft 11 may extend toward the right side.

In the above embodiment, the engine has been described as an example of the prime mover of the present disclosure, but the prime mover of the present disclosure is not limited thereto, and may be a motor. When a motor is used as the prime mover of the present disclosure, the prime mover output shaft of the present disclosure is a motor output shaft.

In the above embodiment, as an example, the transmission mechanism 50 includes the eight gear trains 51A to 51H for shift stages, but the present invention is not limited thereto. The number of gear trains 51 may be any number as long as it is plural.

1. A power train comprising:
a prime mover having a drive output shaft, the prime mover having a prime mover casing constituting an outline of the prime mover;
a transmission casing that is disposed side by side with the prime mover casing in a lateral direction intersecting an axial direction of the drive output shaft and defines a transmission chamber; and
a transmission including a transmission input shaft disposed in parallel with the drive output shaft, and a plurality of gear trains for shift stages of an always-meshing type that are disposed in the transmission chamber and shift and output power input to the transmission input shaft,
wherein the transmission casing includes:
a casing body that defines the transmission chamber; and
an extension portion extending in the lateral direction from the casing body and fixed to the prime mover casing to define a housing chamber that houses a portion of the drive output shaft protruding from the prime mover casing in cooperation with the prime mover casing.

2. The power train according to claim 1, wherein
the prime mover includes a rotating body mechanically connected to the drive output shaft on an axially outer side relative to a bearing that supports the drive output shaft, and
wherein the extension portion defines a rotating body chamber that houses the rotating body in cooperation with the prime mover casing.

3. The power train according to claim 2, wherein the rotating body is a damper or a flywheel.

4. The power train according to claim 2, wherein
the transmission casing defines an adjacent chamber disposed side by side in the axial direction with respect to the rotating body chamber, and
wherein the adjacent chamber houses a power transmission body for transmitting power to the transmission input shaft.

5. The power train according to claim 4, wherein
the drive output shaft includes a connection shaft that connects the power transmission body and the rotating body, and
wherein the extension portion is fitted with a bearing that rotatably supports the connection shaft.

6. The power train according to claim 1, further comprising:
a clutch cover that is attached to the transmission casing and defines a clutch chamber; and
a clutch that connects or disconnects the drive output shaft to or from the transmission input shaft and is housed in the clutch chamber,
wherein the transmission casing includes a partition wall that defines the clutch chamber with the clutch cover.

7. The power train according to claim 6, further comprising a bearing that rotatably supports the transmission input shaft,
wherein the bearing is supported on the partition wall.

8. The power train according to claim 6, further comprising:
an actuator that is disposed in one of the transmission chamber and the clutch chamber and is driven when a pressure medium is supplied; and
a block constituting at least a part of a pressure circuit for applying pressure to the actuator via a pressure medium,
wherein the block is supported on the partition wall.

9. The power train according to claim 6, wherein
the extension portion has a hole through which the drive output shaft is inserted, and
wherein a first seal member that seals the prime mover side in the axial direction and a second seal member that seals the clutch chamber side in the axial direction are disposed on an inner peripheral surface that defines the hole of the extension portion.

10. The power train according to claim 1, wherein the casing body is configured to be attached with an oil cooler for cooling oil in the transmission chamber.

11. The power train according to claim 1, which is mounted on a vehicle having a pair of first drive wheels driven by the power train and a pair of second drive wheels drivable by the power train together with the pair of first drive wheels, the power train further comprising a transmission gear cover that is fastened to the transmission casing and defines the transmission chamber together with the casing body,
wherein the transmission includes a transmission output shaft extending in the transmission chamber, and
wherein the casing body has a hole through which a second drive wheel side output shaft for transmitting power from the transmission output shaft to the pair of second drive wheels is inserted.

12. The power train according to claim 1, which is mounted on a vehicle having a pair of first drive wheels driven by the power train and a pair of second drive wheels drivable by the power train together with the pair of first drive wheels, the power train further comprising a differential mechanism that distributes power transmitted from a transmission output shaft extending in the transmission chamber to the pair of first drive wheels,
wherein the differential mechanism is housed in the casing body.

13. The power train according to claim 1, which is mounted on a vehicle having a vehicle body that supports the power train,
wherein the transmission casing includes:
a first fixing portion that is disposed on a side surface of the casing body opposite to a side surface on which the extension portion is disposed and fixes the transmission casing to the vehicle body; and
a second fixing portion that is disposed on the extension portion and fixes the transmission casing to the vehicle body.

14. A transmission casing, which is configured to be fixed to a prime mover casing constituting an outline of a prime mover having a drive output shaft, and configured to be disposed side by side with the prime mover casing in a lateral direction intersecting an axial direction of the drive output shaft, the transmission casing comprising:
a casing body that defines a transmission chamber for housing a transmission; and
an extension portion extending from the casing body in the lateral direction and configured to seal the prime mover casing when fixed to the prime mover casing.
